(19) United States
(12) Patent Application Publication
(10) Pub. No.: US 2002/0198751 A1
(43) Pub. Date: Dec. 26, 2002

(54) Method for improving information technology infrastructure

(75) Inventors: Leslie Mark Ernest, Knoxville, MD (US); Michelle K. Chank, Hopewell Junction, NY (US); Stephen J. Gwinn, Issaquah, WA (US); William G. Miller, Lexington, SC (US); Peter Nagel, Haworth, NJ (US); Timothy S. O'Malley, Glen Rock, NJ (US); Dennis P. Ondik, Morris Plains, NJ (US)

Correspondence Address: Sean F. Sullivan, Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 09/887,282

(22) Filed: Jun. 22, 2001

(51) Int. Cl. G06F 17/60

(52) U.S. Cl. 705/7; 703/16

(57) ABSTRACT

A method for improving an information technology (IT) infrastructure for an organizational entity is disclosed. In an exemplary embodiment of the invention, the method includes identifying a customer value proposition for the organizational entity, the customer value proposition reflecting an IT end user's perceived value derived from the use of information technology services. A centralization/consolidation strategy for each of a plurality of infrastructure domains is determined, the centralization/consolidation strategy reflecting the degree of centralization and consolidation to be implemented within the domains. Then, a normalized centralization/consolidation strategy over all of the plurality of infrastructure domains is determined, wherein the normalized centralization/consolidation strategy balances the centralization/consolidation strategies for each of the plurality of infrastructure domains, thereby maximizing the value of the information technology services in accordance with the identified customer value proposition.

### BACKGROUND

The present invention relates generally to information technology infrastructures and, more particularly, to a method for improving information technology infrastructure in order to derive maximum value therefrom. In the present context, “infrastructure” refers to all resources used to deliver IT services including, but not limited to, management system processes, technology and organization.

In complex information technology (IT) environments, particularly those resulting from company mergers (e.g., large, multi-national, multi-divisional implementations), it is exceedingly difficult to arrive at a proper balance between consolidated and de-consolidated resource deployment. Further, it is also similarly difficult to arrive at a proper balance between centralized and decentralized distribution of control between business units and the IT function. Both of these factors are important components of value generation.

The determination of consolidation versus de-consolidation affects value by increasing or decreasing cost. Generally speaking, consolidated environments are less costly than de-consolidated environments, as a result of economies of scale which may be attained through consolidation. Where resources are consolidated, there is a tendency for less waste and better overall utilization. On the other hand, consolidated environments also tend to have a negative effect on benefits, which is the other major component of value. De-consolidated environments have evolved, in part, as a result of a perceived lack of customer intimacy; since de-consolidated organizations are not as physically close, they are therefore regarded as less responsive than local resources.

A similar difficulty exists when attempting to balance centralization and decentralization of control within an environment. If an organization is centralized, the control thereof is provided by a central, “headquarters” type function. If decentralized, the policy and decision making functions tend to be pushed toward the edges of the organization. As with consolidation, the degree of centralization or decentralization affects the perceived value derived from the organization. Centralized environments tend to have lower costs because of the lower costs of command and control related to decision making, while decentralized environments tend to be viewed as more responsive and flexible.

In an IT environment, the choices of the degree of centralization and consolidation are made more difficult, primarily due to three factors. First, the choices should be considered across the entire life cycle of the services an IT organization provides. Because most IT organizations are involved in projects ranging from conception to ongoing delivery, factors such as system requirements, gathering, planning, development and delivery should all be taken into account. Secondly, there is also the complexity of the IT infrastructure itself. In addition to hardware and software, personnel are also essential to support the infrastructure. Third, different organizations within an enterprise that have previously utilized IT services may often place a different emphasis on the value to be derived from IT from those organizations that have not. These considerations create a dilemma for an IT service provider with regard to satisfying different demands of these organizations within a single infrastructure.

Accordingly, certain organizational models have evolved which have attempted to address the above described problems. For example, there are in existence a number of “centralized” versus “decentralized” models, along with hybrids thereof, which have attempted to balance and maximize the benefits of the two extremes, while at the same time minimize the negative aspects. However, the problem with the prior approaches stems from addressing individual concerns (e.g., organization or technology architecture) in isolation. As a result, there are currently IT organizations which are in a constant state of reorganization and restructuring. Seemingly, as soon as a reorganization is completed, the difficulties associated with the reorganization are realized, and plans are then made to return the organization to the prior structure.

### BRIEF SUMMARY

The foregoing discussed drawbacks and deficiencies of the prior art are overcome or alleviated by a method for improving an information technology (IT) infrastructure for an organizational entity. In an exemplary embodiment of the invention, the method includes identifying a customer value proposition for the organizational entity, the customer value proposition reflecting an IT end user's perceived value derived from the use of information technology services. A centralization/consolidation strategy for each of a plurality of infrastructure domains is determined, the centralization/consolidation strategy reflecting the degree of centralization and consolidation to be implemented within the domains. Then, a normalized centralization/consolidation strategy over all of the plurality of infrastructure domains is determined, wherein the normalized centralization/consolidation strategy balances the centralization/consolidation strategies for each of the plurality of infrastructure domains, thereby maximizing the value of the information technology services in accordance with the identified customer value proposition.

In a preferred embodiment, identifying a customer value proposition for the organizational entity further comprises determining a relationship profile for the organizational entity. The relationship profile further comprises one of the following: a commodity relationship profile, the commodity relationship profile characterized primarily by cost control and economy of scale objectives; a utility relationship profile, the utility relationship profile characterized by cost control and end-user satisfaction objectives; a partner relationship profile, the partner relationship profile characterized by end-user satisfaction and localized control objectives; and an enabler relationship profile, the enabler relationship profile characterized by end-user satisfaction and standardization objectives.

### BRIEF DESCRIPTION OF THE DRAWINGS

Referring to the exemplary drawings wherein like elements are numbered alike in the several Figures:

FIG. 1 is a cost versus benefit graph which illustrates a set of customer value propositions between information technology and its customers;

FIG. 2 is a graph which illustrates a zone of perceived value for an IT infrastructure;

FIG. 3 is a strategy matrix which outlines a general centralization and consolidation strategy for a given IT infrastructure domain;

FIG. 4 is a descriptive strategy matrix which illustrates some the characteristics of enterprises which fall into the various quadrants therein;

FIG. 5 is another matrix illustrating the set of customer value propositions applied to the matrix shown in FIG. 3;

FIG. 6 illustrates is a linkage identification between individual attributes within various domain elements;

FIG. 7 is a three dimensional matrix illustrating the four general customer value propositions applied across each of the IT infrastructure domains;

FIG. 8 is a table which generally describes the results of a centralization/consolidation strategy upon the individual domains of an IT infrastructure;

FIG. 9 is a flow diagram summarizing a method for improving an information technology infrastructure for an organizational entity, in accordance with an embodiment of the invention.

### DETAILED DESCRIPTION

In accordance with an embodiment of the invention, there is disclosed a method for improving an information technology (IT) infrastructure for an organizational entity. In an embodiment of the invention, the improvement of the IT infrastructure results in the optimization of the IT infrastructure. Rather than addressing the individual components of an IT infrastructure in isolation, the present approach provides a holistic approach to IT optimization which considers the factors of centralization/decentralization, simultaneously with consolidation/de-consolidation. Furthermore, this approach is applied across the several aspects or domains of the IT infrastructure while, at the same time, being grounded within the expectation of value from the enterprise or IT customer.

Referring initially to FIG. 1, there is shown a cost versus benefit graph 10 which illustrates a set of customer value propositions between information technology and its customers. In one sense, the graph 10 in FIG. 1 reflects the attitude of the customer toward the IT used by the customer. In another sense, the graph 10 also indicates the perceived value derived by the customer from the IT itself, which perceived value is a function of both cost and benefit. At one extreme, the customer may simply view IT as a commodity or tool, in that the IT is a basic service to be utilized at the lowest possible cost. At the other extreme, the customer may view the IT as an essential feature which enables the business to carry out its essential operations. Naturally, in this case, the associated costs therefrom are higher.

Although FIG. 1 appears as a discrete set of value propositions, in reality it represents a continuum of value choices, which may be applied globally to an enterprise, or directed at individual businesses within the enterprise. However, for purposes of IT optimization, the value continuum may be categorized by four general profiles, described in further detail as follows:

Commodity

The Commodity relationship profile 12 is applicable to an enterprise which views IT services as a commodity and is focused primarily on cost, both with regard to the impact of technology utilization and to the cost in providing the services. The IT is used to automate rudimentary administrative functions (e.g., payroll, accounts receivable) at the lowest possible cost. IT services in such an enterprise are prime candidates for outsourcing, as an outsource provider can generally provide standard services at lower costs based upon economies of scale, Cost control and economies of scale are fundamental objectives of enterprises in this profile, with these objectives even being pursued at the expense of customer satisfaction, functionality and performance of the IT infrastructure. It is expected that such an enterprise would tend toward maximizing consolidation and centralization of the IT infrastructure as a means of controlling costs.

Other expected characteristics of an enterprise falling under this profile may be, for example, that the IT organization thereof would be found as a sub-function of the enterprise's financial organization, again reflecting the cost controlling focus of the enterprise. Further, the information technology itself is likely to be of a mainframe/host nature, with almost no technical innovation, and including hardware/software which is not of the most recent generation.

Utility

For those enterprises falling within the Utility relationship profile 14 on the value continuum, the IT infrastructure cost is still a primary factor. However, in this category there is a recognition of, and concern for, customers (or end users) of the IT services. Consequently, there is a degree of reduction in the focus on local control and economies of scale. While the IT organization is primarily centralized enterprise-wide, there may be “pockets” of IT scattered throughout the enterprise.

Individual business units within such an enterprise may begin to recognize the value of IT services. If so, there may be potential conflicts between cost control objectives and end user satisfaction if the centralized IT organization does not adequately respond to end user concerns. Enterprises within this profile may even have “charge back” mechanisms therein, where it is an objective to have the IT organization be self-sustaining (i.e., having a zero-based budget).

Partner

In the Partner relationship profile 16, the value of IT services receives even greater recognition within an enterprise. This greater recognition is so reflected within the IT infrastructure itself. The leader of an IT infrastructure within such an enterprise may even be on a peer level with corresponding leaders of other business units in the enterprise. Customer or end user satisfaction is a priority, and this is demonstrated by the existence of discrete IT organizations within the business units. These discrete IT organizations may be primarily dedicated toward solution development (e.g., application programmers) in response to the needs, requirements and priorities of the end users.

As a result, there is less direct control of the IT infrastructure, as well as lower economies of scale. On the other hand, to be effective, a centralized IT organization will still maintain a margin of control over the IT services. The IT organization focuses on the effective and efficient use of technology throughout the enterprise, but with a clear vision/mission to support the business units in achieving their business objectives. While cost is still somewhat of a concern, the primary focus of the IT services is the business benefit derived therefrom. In such an enterprise, it is less likely to find tension between an enterprise-wide IT organization and individual business unit IT organizations.

Enabler

Finally, in an enterprise falling under the Enabler relationship profile 18, the IT is viewed as central to the overall business strategy, being elevated from a “participant” in the enterprise to a leader in the enterprise. Unlike enterprises in the Commodity and Utility profiles, control of an enterprise in the Enabler profile is achieved through the use of the IT process itself. The head of the IT organization controls the IT process and, therefore, the IT. In such an organization, a hierarchical reporting structure is almost irrelevant. The use of IT has equal prominence as any other business element contributing to the business objectives.

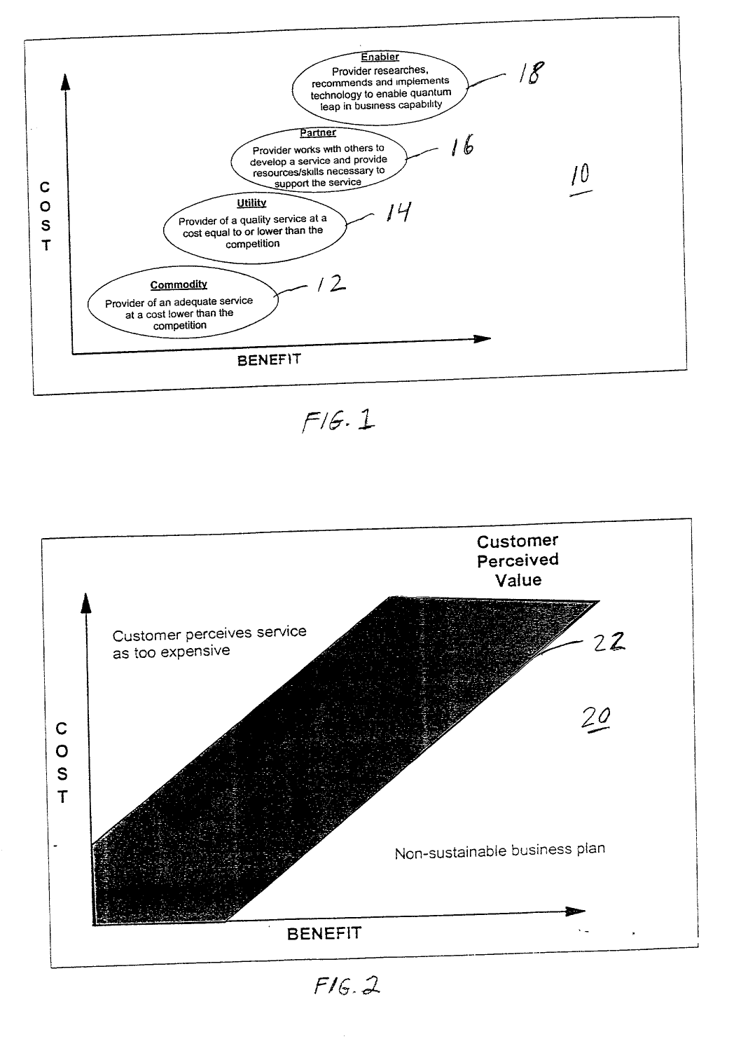

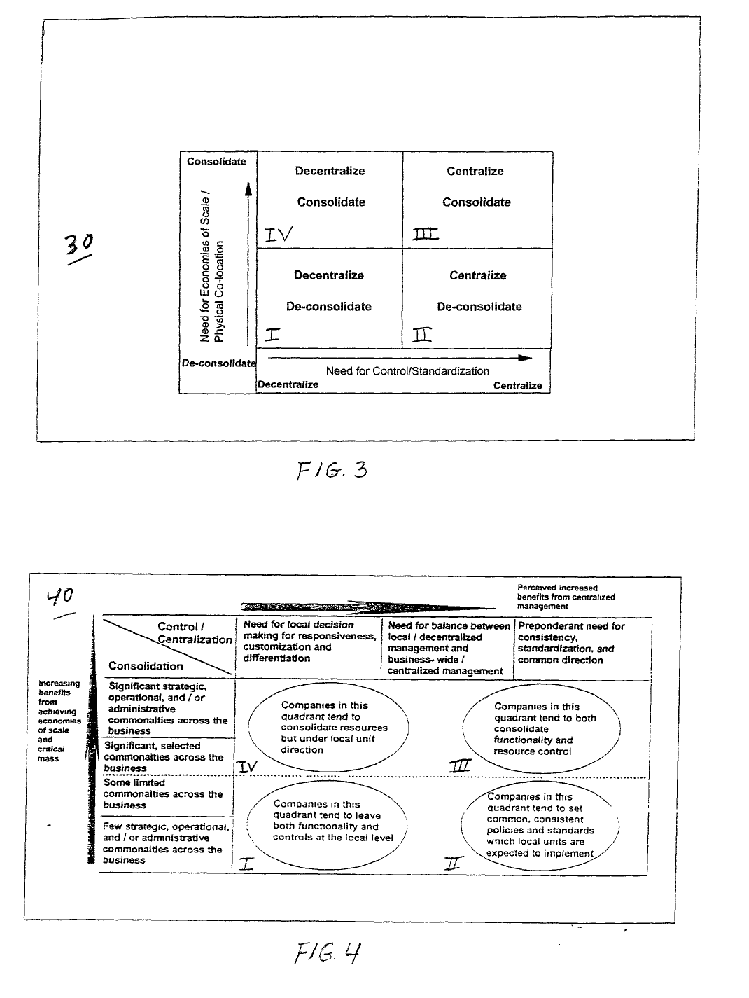

Referring now to FIG. 2, the above-described value propositions may be found within a continuum, or “zone of perceived value” for an IT infrastructure. This zone of perceived value on the graph 20 is located within shaded area 22. As can be seen from graph 20, as costs and benefits increase or decrease at about the same rate, the customer perceived value will be balanced (falling somewhere within shaded area 22). Within the shaded area 22, the Commodity relationship profile is found in the lower left portion thereof, where costs and benefits of the IT infrastructure are low. As both costs and benefits begin to increase at a relatively proportional rate, the profile enters the Utility area. Further cost/benefit increases result in the Partner profile and, ultimately to a point where the Enable profile is reached.

However, if the costs of an IT infrastructure heavily outweigh the desired benefits, the customer will be dissatisfied with the perceived value. On the other hand, if the expected benefit is much greater that the amount willing to be paid for the IT services, then the business objectives themselves are not sustainable. In either situation, there is a lack of proper balance between the costs and benefits for a given IT environment.

It will be appreciated from the above description that, depending upon the specific customer value proposition characteristic of a given enterprise, the optimal IT infrastructure thereof (in terms of centralization and consolidation factors) will vary. Therefore, in accordance with the present method, the customer value proposition of the organizational entity is first identified. This may be accomplished by such techniques as through a series of structured interviews and workshops within the customer/end user population.

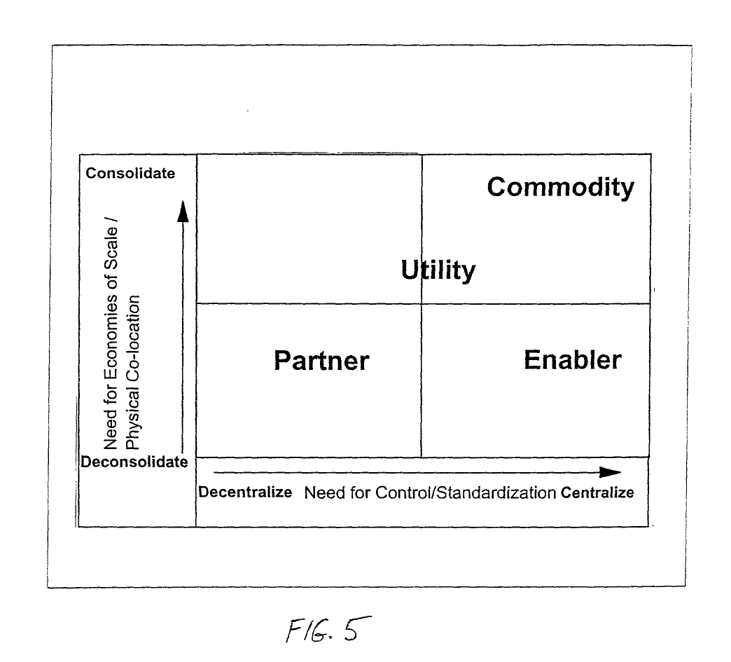

Once the customer value proposition is identified, the next step in the optimization method is to then apply the identified customer value proposition to determine a centralization/consolidation strategy for each of several domains (or aspects) which make up an entire IT infrastructure. In FIG. 3, there is shown a strategy matrix 30 which outlines a general centralization and consolidation strategy, depending upon the benefits to be derived therefrom, and in view of the customer value proposition. The horizontal portion of matrix 30 illustrates the degree of centralization desired, wherein the greater the need for control and standardization of the IT, the further to the right of the matrix 30 the ultimate strategy appears (more centralization). Conversely, the less the need exists for control and standardization, the further to the left of the matrix 30 the ultimate strategy appears (less centralization).

The vertical portion of matrix 30 illustrates the degree of consolidation desired, wherein the greater the need for economies of scale and physical co-location of the IT, the higher up on the matrix 30 the ultimate strategy appears (more consolidation). Conversely, the less the need exists for economies of scale and physical co-location, the lower up on the matrix 30 the ultimate strategy appears (less consolidation). With both centralization and consolidation factoring into an IT optimization strategy, therefore, matrix 30 may be separated into four quadrants. For ease of description, “quadrant I” refers to decentralized/de-consolidated strategy, “quadrant II” refers to a centralized/de-consolidated strategy, “quadrant III” refers to a centralized/consolidated strategy, and “quadrant IV” refers to a decentralized/consolidated strategy.

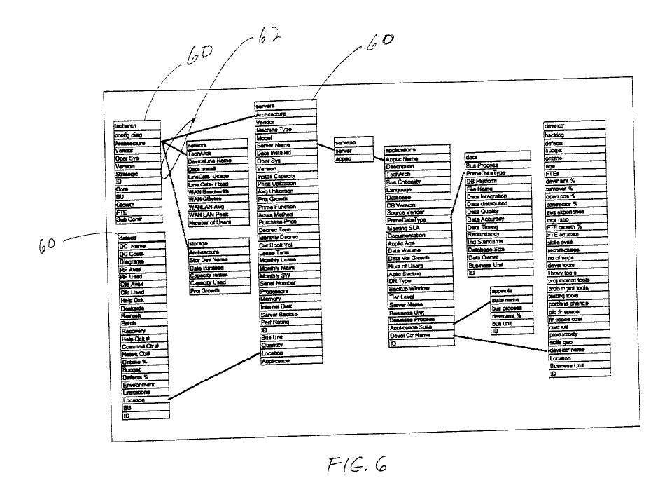

FIG. 4 is a more descriptive strategy matrix 40 which illustrates some the characteristics of enterprises which fall into the various quadrants. For example, if an enterprise tends to leave functionality and control at a local level, then it tends to fall under the decentralized/de-consolidated strategy of quadrant I. The further to the right of matrix 40 an enterprise falls, the greater that enterprise perceives benefits from centralized management. In addition, the further to the top of matrix 40 an enterprise falls, the greater that enterprise perceives benefits from economies of scale and physical co-location.

Referring now to FIG. 5, the four general customer value propositions described earlier are now applied to the matrix illustrated in FIG. 3. It has been found that the Commodity relationship profile fits into quadrant III, which favors a centralized, consolidated strategy for IT. The Utility relationship profile tends more toward consolidation for cost purposes, but may tend toward either centralization or de-centralization due to increased concern for the end user. Therefore, “Utility” is shown in both quadrants III and IV in FIG. 5. The Enabler relationship profile, while favoring de-consolidation, also favors a more centralized structure given the importance of the IT in the business operations. Thus, “Enabler” fits into quadrant II. Lastly, a Partner relationship profile (where cost is less of an issue but end user considerations are high) falls into quadrant I, which favors a decentralized, de-consolidated strategy.

In prior IT optimatization methods, the inquiry would ordinarily end at this stage as instinctively, it might appear that a single centralization/consolidation strategy is warranted for an enterprise, based solely upon a customer value proposition and its position within the strategy matrix. However, in order to obtain an optimal IT infrastructure strategy, the cost/benefit effect upon all IT infrastructure domains should be considered. The domains within an IT infrastructure (in no particularly significant order) may be described as follows:

Technology (Infrastructure Hardware)

This domain encompasses all IT hardware including, but not limited to, servers, mainframes, storage, printers, tape, desktop hardware, operating systems, software and architectures.

Network

This domain encompasses all hardware/middleware used to connect infrastructure components and desktop including, but not limited to, routers, LAN/WAN, high-speed internet connections, topology and sourcing decisions.

Applications and Data

This domain encompasses all software other than operating systems software, enterprise business data and alignment with business processes.

Organization (Personnel)

This domain encompasses the structure, behaviors, enablers, skills, job descriptions and actual personnel involved in the delivery of the IT function and organizational change management factors.

Process

This domain encompasses all management system activities related to planning, development, operation and maintenance of the IT function.

Environment

This domain encompasses the IT general ledger, budgeting, procurement and facilities (e.g., offices for IT staff) placement and sizing.

Each of these domains has an individual influence on the overall perceived value of the IT infrastructure, which value may be described by the following equation:

Value=(bT+bN+bA+bO+bP+bE)−(cI+cN+cA+cO+cP+cE);

wherein “b” preceding a capital letter is the total benefit contribution provided by the domain represented by that capital letter. Thus, for example, “bT” is the total benefit contribution of the technology domain of the IT infrastructure. Conversely, “c” preceding a capital letter is the total cost associated with the domain represented by that capital letter. For example, “cN” is the total cost associated with the network domain of the IT infrastructure.

Both the total benefit and total cost of each domain may further be broken down by adding the respective benefits and costs of each particular element within a domain. Thus, for example:

Total benefit of technology (bT)=(bTe₁+bTe₂+ . . . +bTe_{N});

wherein e₁ through e_{N} represent individual elements within a given domain. The same holds true for the total costs of a domain:

Total costs of technology (cT)=(cTe₁+cTe₂+ . . . +cTe_{N}).

In most domain environments, determining the costs of each individual element of a domain (e.g., cTe₁ through cTe_{N}) is a relatively simple proposition. However, the more complex the domain environment, the more difficult it is to arrive at accurate individual costs. In such cases, an automated means for cost data capture may be desirable. The identification of individual element benefits within a domain, on the other hand, is a more difficult task. In order to approximate the benefits provided by an element, a linkage is made between the domain elements and the business function that element provides or support.

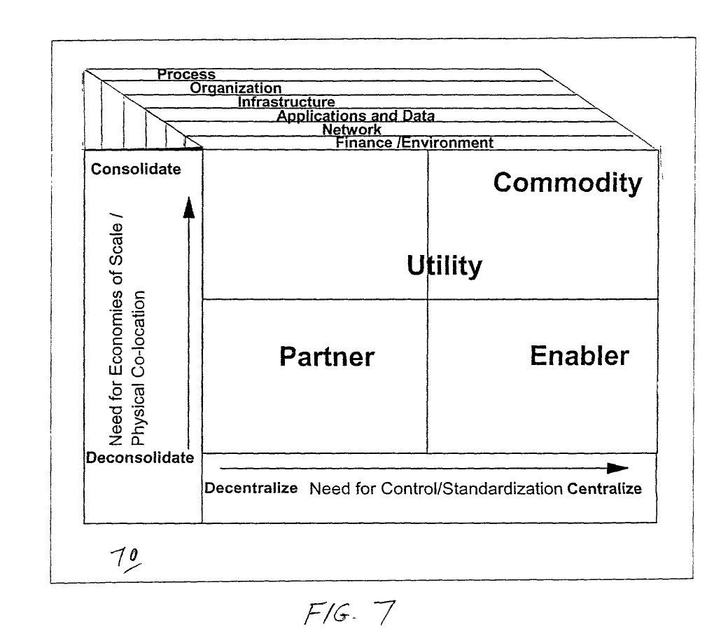

FIG. 6 illustrates an example of this linkage identification. A series of columns 60 are headed by certain exemplary domain elements, along with the individual attributes of the domain element thereunder. Further, common attributes contained within various domain elements are able to be identified, as well as linking technology components to the function they provide. For example, lines 62 illustrate that “architecture” is a common attribute link between domain elements “techarch”, “network”, “storage” and “servers”. Thus, this attribute plays a role in several domain elements and likely provides greater benefit (and therefore value) to an enterprise.

Once each of the domain elements have been identified and the business benefits thereof are determined, then the next step in the IT optimization method is to determine a normalized centralization/consolidation strategy across each domain, which corresponds to the customer value proposition identified earlier. According to the value equation outlined above, the perception of value is increased whenever costs are reduced. Thus, each domain is examined for opportunities to reduce costs therewithin, up to the point where additional cost reductions have a negative impact upon benefits and perceived value. More specifically, opportunities for physical consolidation, standardization, simplification and elimination are examined.

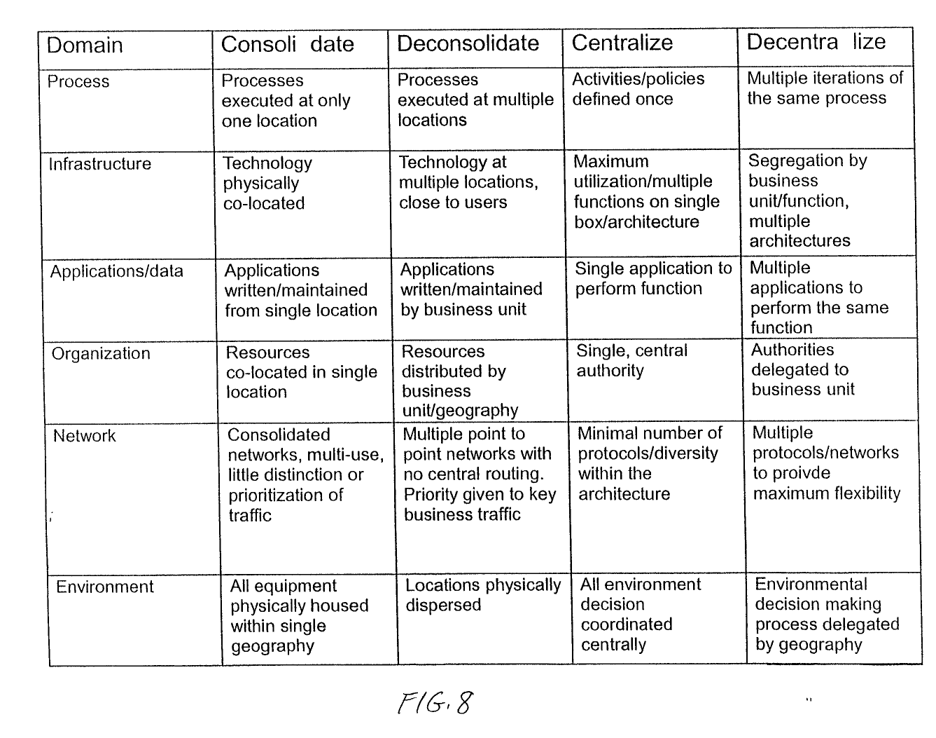

FIG. 7 is a three dimensional matrix illustrating the four general customer value propositions applied across each of the IT infrastructure domains. In general, the positioning in the matrix across each domain (and hence the determination of a normalized centralization/consolidation strategy) will be in accordance with the individual strategies outlined in FIGS. 3-5. However, because each domain is being considered as a whole, a particular centralization/consolidation strategy for one domain may be, to a certain extent, in conflict with a particular centralization/consolidation strategy for another domain. Thus, a “best fit” or normalized centralization/consolidation strategy is determined which takes into account the cost/benefit analysis described above for each domain element.

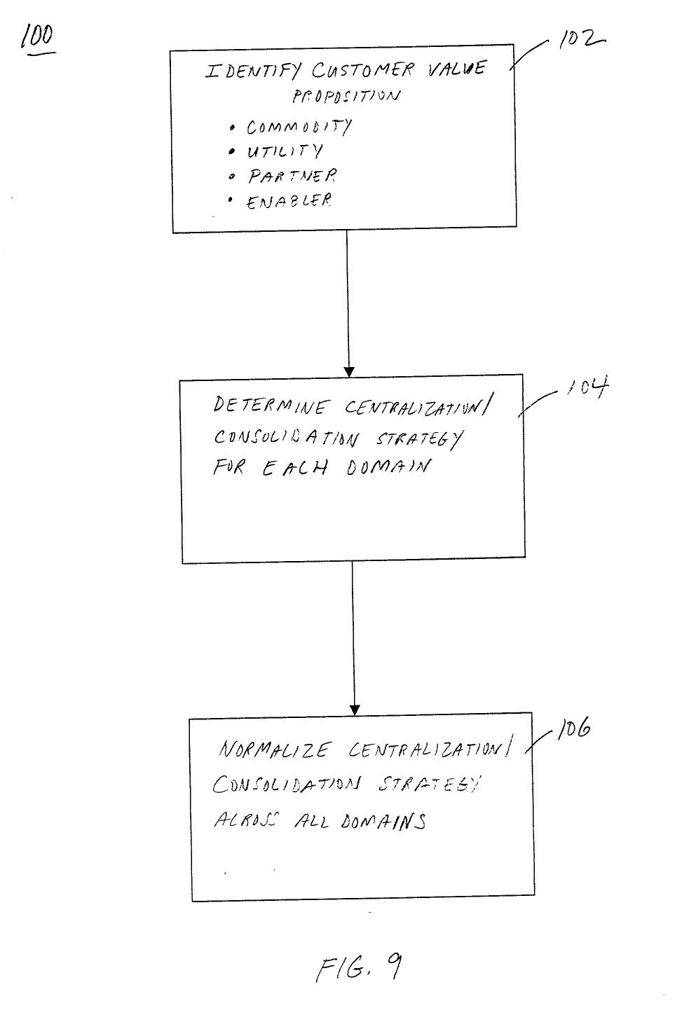

FIG. 8 is a table which generally describes the results of a centralization/consolidation strategy upon the individual domains of an IT infrastructure. For example, a consolidated, decentralized approach with regard to applications/data is characterized by the applications being written and maintained from a single location, wherein multiple applications may perform the same function. Through the use of the foregoing method, the IT infrastructure is optimized because all IT infrastructure domains are considered as a whole, keeping in mind the customer value proposition placed upon the IT itself.

Finally, FIG. 9 is a flow diagram summarizing the aforedescribed embodiment of a method 100 for improving an information technology infrastructure for an organizational entity. Block 102 illustrates the identification of a customer value proposition for an organizational entity (e.g., commodity, utility, partner, enabler). At block 104, the process by which a centralization/consolidation strategy for each of the above-described infrastructure domains is determined. Then, at block 106, a normalized centralization/consolidation strategy balances the centralization/consolidation strategies for each of the infrastructure domains, thereby maximizing the value of the information technology services in accordance with the identified customer value proposition.

The present invention can include embodiments in the form of computer-implemented processes and apparatuses for practicing those processes. The present invention can also include embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also include embodiments in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for improving an information technology (IT) infrastructure for an organizational entity, the method comprising:
identifying a customer value proposition for the organizational entity, said customer value proposition reflecting an IT end user's perceived value derived from the use of information technology services;
determining a centralization/consolidation strategy for each of a plurality of infrastructure domains, said centralization/consolidation strategy reflecting the degree of centralization and consolidation to be implemented within said domains; and
determining a normalized centralization/consolidation strategy over all of said plurality of infrastructure domains;
wherein said normalized centralization/consolidation strategy balances said centralization/consolidation strategies for each of said plurality of infrastructure domains, thereby maximizing the value of said information technology services in accordance with said identified customer value proposition.

2. The method of claim 1, wherein said identifying a customer value proposition for the organizational entity further comprises determining a relationship profile for the organizational entity, said relationship profile further comprising one of a:
a commodity relationship profile, said commodity relationship profile characterized primarily by cost control and economy of scale objectives;
a utility relationship profile, said utility relationship profile characterized by cost control and end-user satisfaction objectives;
a partner relationship profile, said partner relationship profile characterized by end-user satisfaction and localized control objectives; and
an enabler relationship profile, said enabler relationship profile characterized by end-user satisfaction and standardization objectives.

3. The method of claim 1, wherein said centralization/consolidation strategy further comprises one of:
a centralized, consolidated strategy;
a centralized, de-consolidated strategy;
a decentralized, consolidated strategy; and
a decentralized, de-consolidated strategy.

4. The method of claim 3, wherein:
a centralized strategy is characteristic of an increased emphasis on control and standardization of the IT infrastructure;
a decentralized strategy is characteristic of a decreased emphasis on control and standardization of the IT infrastructure;
a consolidated strategy is characteristic of an increased emphasis on economies of scale and physical co-location of IT infrastructure elements; and
a de-consolidated strategy is characteristic of a decreased emphasis on economies of scale and physical co-location of IT infrastructure elements.

5. The method of claim 4, further comprising:
identifying individual elements within said domains;
identifying costs associated with said individual elements;
identifying benefits associated with said individual elements; and
performing a cost/benefit analysis for said elements within said domains;
wherein said value of said information technology services is determined by subtracting the sum total of said costs of each of said elements within each of said domains from the sum total of the benefits of each of said elements within each of said domains.

6. The method of claim 5, wherein identifying benefits associated with said individual elements further comprises:
identifying attributes of said individual elements; and
determining common attributes among said individual elements, thereby linking said individual elements with a business function provided thereby.

7. A storage medium encoded with a machine readable computer program code for improving an information technology (IT) infrastructure for an organizational entity, the storage medium including instructions for causing a computer to implement a method, the method comprising:
identifying a customer value proposition for the organizational entity, said customer value proposition reflecting an IT end user's perceived value derived from the use of information technology services;
determining a centralization/consolidation strategy for each of a plurality of infrastructure domains, said centralization/consolidation strategy it reflecting the degree of centralization and consolidation to be implemented within said domains; and
determining a normalized centralization/consolidation strategy over all of said plurality of infrastructure domains;
wherein said normalized centralization/consolidation strategy balances said centralization/consolidation strategies for each of said plurality of infrastructure domains, thereby maximizing the value of said information technology services in accordance with said identified customer value proposition.

8. The storage medium of claim 7, wherein said identifying a customer value proposition for the organizational entity further comprises determining a relationship profile for the organizational entity, said relationship profile farther comprising one of a:
a commodity relationship profile, said commodity relationship profile characterized primarily by cost control and economy of scale objectives;
a utility relationship profile, said utility relationship profile characterized by cost control and end-user satisfaction objectives;
a partner relationship profile, said partner relationship profile characterized by end-user satisfaction and localized control objectives; and
an enabler relationship profile, said enabler relationship profile characterized by end-user satisfaction and standardization objectives.

9. The storage medium of claim 7, wherein said centralization/consolidation strategy further comprises one of:
a centralized, consolidated strategy;
a centralized, de-consolidated strategy;
a decentralized, consolidated strategy; and
a decentralized, de-consolidated strategy.

10. The storage medium of claim 9, wherein:
a centralized strategy is characteristic of an increased emphasis on control and standardization of the IT infrastructure;
a decentralized strategy is characteristic of a decreased emphasis on control and standardization of the IT infrastructure;
a consolidated strategy is characteristic of an increased emphasis on economies of scale and physical co-location of IT infrastructure elements; and
a de-consolidated strategy is characteristic of a decreased emphasis on economies of scale and physical co-location of IT infrastructure elements.

11. The storage medium of claim 10, further comprising:
identifying individual elements within said domains;
identifyng costs associated with said individual elements;
identifying benefits associated with said individual elements; and
performing a cost/benefit analysis for said elements within said domains;
wherein said value of said information technology services is determined by subtracting the sum total of said costs of each of said elements within each of said domains from the sum total of the benefits of each of said elements within each of said domains.

12. The storage medium of claim 11, wherein identifying benefits associated with said individual elements further comprises:
identifying attributes of said individual elements; and
determining common attributes among said individual elements, thereby linking said individual elements with a business function provided thereby.

13. A computer data signal for improving an information technology (IT) infrastructure for an organizational entity, the computer data signal comprising code configured to cause a processor to implement a method, the method comprising:
identifying a customer value proposition for the organizational entity, said customer value proposition reflecting an IT end user's perceived value derived from the use of information technology services;
determining a centralization/consolidation strategy for each of a plurality of infrastructure domains, said centralization/consolidation strategy reflecting the degree of centralization and consolidation to be implemented within said domains; and
determining a normalized centralization/consolidation strategy over all of said plurality of infrastructure domains;
wherein said normalized centralization/consolidation strategy balances said centralization/consolidation strategies for each of said plurality of infrastructure domains, thereby maximizing the value of said information technology services in accordance with said identified customer value proposition.

14. The computer data signal of claim 13, wherein said identifying a customer value proposition for the organizational entity further comprises determining a relationship profile for the organizational entity, said relationship profile further comprising one of a:
a commodity relationship profile, said commodity relationship profile characterized primarily by cost control and economy of scale objectives;
a utility relationship profile, said utility relationship profile characterized by cost control and end-user satisfaction objectives;
a partner relationship profile, said partner relationship profile characterized by end-user satisfaction and localized control objectives; and
an enabler relationship profile, said enabler relationship profile characterized by end-user satisfaction and standardization objectives.

15. The computer data signal of claim 13, wherein said centralization/consolidation strategy further comprises one of:
a centralized, consolidated strategy;
a centralized, de-consolidated strategy;
a decentralized, consolidated strategy; and
a decentralized, de-consolidated strategy.

16. The computer data signal of claim 15, wherein:
a centralized strategy is characteristic of an increased emphasis on control and standardization of the IT infrastructure;
a decentralized strategy is characteristic of a decreased emphasis on control and standardization of the IT infrastructure;
a consolidated strategy is characteristic of an increased emphasis on economies of scale and physical co-location of IT infrastructure elements; and
a de-consolidated strategy is characteristic of a decreased emphasis on economies of scale and physical co-location of IT infrastructure elements.

17. The computer data signal of claim 16, further comprising:
identifying individual elements within said domains;
identifying costs associated with said individual elements;
identifying benefits associated with said individual elements; and
performing a cost/benefit analysis for said elements within said domains;
wherein said value of said information technology services is determined by subtracting the sum total of said costs of each of said elements within each of said domains from the sum total of the benefits of each of said elements within each of said domains.

18. The computer data signal of claim 17, wherein identifying benefits associated with said individual elements further comprises:
identifying attributes of said individual elements; and
determining common attributes among said individual elements, thereby linking said individual elements with a business function provided thereby.
